(19) United States
(12) Patent Application Publication
(10) Pub. No.: US 2014/0137205 A1
(43) Pub. Date: May 15, 2014

(54) System and Method for Automatic Provisioning of Managed Devices

(71) Applicant: OpenPeak Inc., (US)

(72) Inventors: John R. Brown, Boynton Beach, FL (US); Robert M. Dare, Sunrise, FL (US); Andy A. Aiello, Boca Raton, FL (US)

(21) Appl. No.: 13/856,524

(22) Filed: Apr. 4, 2013

Related U.S. Application Data
(60) Provisional application No. 61/620,661, filed on Apr. 5, 2012.

(51) Int. Cl. H04L 12/24

(52) U.S. Cl. CPC H04L 41/28
USPC 726/4

(57) ABSTRACT

A method and system for automatic provisioning of communication devices is described herein. The method can include the steps of receiving a pre-authorization request from a communication device and receiving an authorization request based on the pre-authorization request in which the authorization request may be in a first form. The method can also include the steps of converting the authorization request into a second form that may be recognizable by a directory service and obtaining an authorization approval from the directory service. The authorization approval may include a functional indicator that corresponds to a function associated with the operation of the communication device. Based on the authorization approval, the communication device may be established as a managed communication device. In addition, a bundle may be delivered to the managed communication device based on the functional indicator.

### CROSS-REFERENCE TO RELATED APPLICATIONS

This patent application claims priority to U.S. Patent Application No. 61/620,661, filed on Apr. 5, 2012, which is incorporated herein by reference in its entirety.

### FIELD OF TECHNOLOGY

The present subject matter relates to systems and methods for provisioning of devices in a managed environment.

### BACKGROUND

There is a current move in the mobile device industry to enable the management of such devices on behalf of enterprises. For example, an enterprise may provide mobile devices to its employees and may wish to have those devices managed. Alternatively, an enterprise may permit sensitive applications and data to be installed on the personal mobile devices of its employees, which may lead to a management scheme being implemented for these devices. In either arrangement, the managed devices need to be registered with a managing service and correctly provisioned with certain software packages and policies. This provisioning process is daunting, especially considering the number of devices that need to be handled. As such, there is a need to streamline this process.

### SUMMARY

A method for automatic provisioning of communication devices is described herein. The method can include the steps of receiving a pre-authorization request from a communication device and receiving an authorization request based on the pre-authorization request in which the authorization request is in a first form. The method can also include the steps of converting the authorization request into a second form that may be recognizable by a directory service and obtaining an authorization approval from the directory service. The authorization approval can include a functional indicator that can correspond to a function associated with the operation of the communication device. Based on the authorization approval, the communication device can be established as a managed communication device. The method can also include the step of delivering a bundle to the managed communication device based on the functional indicator.

In one arrangement, the pre-authorization request may include an enterprise identifier. Also, the method can further include the step of redirecting the pre-authorization request to a provisioning facilitator based on the enterprise identifier, and the provisioning facilitator may be assigned to an enterprise that may be assigned the enterprise identifier. The method can also include the step of mapping data elements associated with a management service with data elements of the directory service to enable the converting of the authorization request from the first form to the second form that is recognizable by the directory service. In another arrangement, the method can further include the steps of converting the authorization approval into the first form and transmitting the authorization approval to the communication device.

The method can further include the steps of decrypting the pre-authorization request when the pre-authorization request is received from the communication device, decrypting the authorization request when the authorization request is received and encrypting the authorization approval when the authorization approval is obtained from the directory service. As an example, the directory service may be part of a protected environment of an enterprise, and the method can further include the step of receiving the functional indicator from the directory service. The method can also include the step of receiving a features report from the communication device in which the features report may include operational capabilities of the communication device.

Another method for automatically provisioning a communication device is described herein. The method can include the steps of receiving identification information that is used to form a pre-authorization request and sending the pre-authorization request to a management service. Based on feedback from the management service, an authorization request can be sent to a provisioning facilitator in which the authorization request is in a form that is recognizable by the management service.

The authorization request can also be received in a form that is recognizable by a directory service. In response to the authorization request, an authorization approval can be selectively provided in the form that may be recognizable by the directory service. The method can also include the steps of receiving the authorization approval in a form that may be recognizable by the managing service and based on the authorization approval, receiving at the communication device a bundle that can be selected in view of a function of a user who is associated with the directory service.

In one arrangement, the identification information can include an enterprise identifier, and the enterprise identifier may be associated with the provisioning facilitator that receives the authorization request. The method can also include the steps of encrypting the pre-authorization request for transmission to the management service and decrypting the authorization approval when the authorization approval is received. As another example, the authorization approval can include a functional indicator, and the functional indicator may determine the bundle that the communication device receives.

In another arrangement, the method can include the step of—prior to authenticating the communication device—restricting user information from storage at the management service and the step of storing the user information at the directory service prior to and following the authentication of the communication device. The method can further include the step of selectively providing data elements of the directory service to enable the provisioning facilitator to map the data elements of the directory service to data elements of the managing service. In yet another arrangement, the method can include the steps of determining one or more operational capabilities of the communication device and sending the operational capabilities to the management service as part of a features report. The features report may affect the provisioning of the communication device.

Another method of automatically provisioning a communication device is described herein. The method can include the steps of receiving identification information, generating a pre-authorization request based on the identification information and sending the pre-authorization request to a management service. Based on feedback from the management service, an authorization request can be sent to a provisioning facilitator that is communicatively coupled to a directory service in a protected environment of an enterprise. The method can also include the steps of receiving from the provisioning facilitator an authorization approval, sending the authorization approval to the management service and receiving a bundle from the management service. The bundle may be based on a function of a user who is associated with the enterprise.

A system for automatic provisioning of communication devices is described herein. The system can include a management server, and the management server can be configured to receive a pre-authorization request from a communication device. The system may also include a provisioning facilitator in which the provisioning facilitator may be configured to communicate with a directory service of an enterprise. The management server may be further configured to redirect the communication device to the provisioning facilitator based on the pre-authorization request. The provisioning facilitator may be further configured to receive an authorization request from the communication device in a form that may be recognizable by the management server and to convert the authorization request into a form that may be recognizable by the directory service. Additionally, the provisioning facilitator can be configured to receive an authorization approval from the directory service. Based on this authorization approval, the management server can be further configured to deliver a bundle to the communication device to convert the communication device to a managed communication device.

The management server may be further configured to deliver the bundle to the communication device based on a function of a user of the communication device. In one arrangement, the management server can include a table that may store identities of one or more provisioning facilitators. As an example, the pre-authorization request may contain an enterprise identifier, and the management server may include a processor. The processor can search the table for a provisioning facilitator that may correspond to the enterprise identifier to determine which provisioning facilitator is to receive the authorization request from the communication device.

The management server may also include an encryption engine that is configured to decrypt the pre-authorization request from the communication device and to encrypt the bundle that is delivered to the communication device. In another embodiment, the management server can include one or more storage units that may be configured to store bundles that can be delivered to the communication devices.

The provisioning facilitator can be further configured to map data elements that may be associated with the management server to data elements that may be associated with the directory service. In addition, the directory service may be within a protected environment of the enterprise, and the provisioning facilitator can be outside the protected environment of the enterprise. In another embodiment, the management server can be further configured to receive and process a features report from the communication device in which the features report may include operational capabilities of the communication device.

A communication device is also described herein. The communication device can include a user interface element that can be configured to receive identification information that is associated with a user who is assigned to an enterprise and can also include a transceiver that can be configured to receive and transmit communication signals. The communication device can also include a processor that may be communicatively coupled to the user interface element and the transceiver. The processor can be configured to generate a pre-authorization request based on the identification information and to cause the transceiver to send the pre-authorization request to a management service. Based on feedback from the management service, the processor can cause the transceiver to send an authorization request to a provisioning facilitator that may be communicatively coupled to a directory service of the enterprise. The processor can also be configured to receive an authorization approval from the provisioning facilitator and to cause the transceiver to send the authorization approval to the management service. The processor may also be configured to receive and process a bundle from the management service in which the bundle may be based on a function of the user who is assigned to the enterprise.

As an example, the identification information includes an identifier for the enterprise, and the identifier for the enterprise can be a domain name. The communication device can also include an encryption engine in which the encryption engine can be configured to encrypt the pre-authorization request and the authorization approval prior to transmission to the management service and to decrypt the authorization approval from the provisioning facilitator. The processor may also be configured to to generate a features report for transmission to the management service in which the features report may include operational capabilities of the communication device.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate certain non-limiting embodiments and, together with the description, further serve to explain the principles of these embodiments.

FIG. 1 illustrates an example of a system for automatic provisioning of communication devices.

FIG. 2 illustrates an example of some of the components of FIG. 1 in more detail.

FIG. 3 illustrates an example of a method for automatic provisioning of communication devices.

Applicants expressly disclaim any rights to any third-party trademarks or copyrighted images included in the figures. Such marks and images have been included for illustrative purposes only and constitute the sole property of their respective owners.

The features and advantages of the non-limiting embodiments will become more apparent from the detailed description set forth below when taken in conjunction with the drawings, in which like reference characters identify corresponding elements throughout. In the drawings, like reference numbers generally indicate identical, functionally similar, and/or structurally similar elements.

### DETAILED DESCRIPTION

The following detailed description refers to the accompanying drawings that illustrate exemplary embodiments; however, the scope of the present claims is not limited to these embodiments. Thus, embodiments beyond those shown in the accompanying drawings, such as modified versions of the illustrated embodiments, may nevertheless be encompassed by the present claims.

References in the specification to “one embodiment,” “an embodiment,” “an example embodiment,” “one arrangement,” “an arrangement” or the like, indicate that the embodiment or arrangement described may include a particular feature, structure, or characteristic, but every embodiment may not necessarily include the particular feature, structure, or characteristic. Moreover, such phrases are not necessarily referring to the same embodiment or arrangement. Furthermore, when a particular feature, structure, or characteristic is described in connection with an embodiment or arrangement, it is submitted that it is within the knowledge of one skilled in the art to implement such feature, structure, or characteristic in connection with other embodiments or arrangements whether or not explicitly described.

Several definitions that apply throughout this document will now be presented. The term “exemplary” as used herein is defined as an example or an instance of an object, apparatus, system, entity, composition, method, step or process. The term “communicatively coupled” is defined as a state in which two or more components are connected such that communication signals are able to be exchanged between the components on a unidirectional or bidirectional (or multi-directional) manner, either wirelessly, through a wired connection or a combination of both. A “computing device” is defined as a component that is configured to perform some process or function for a user and includes both mobile and non-mobile devices. A “communication device” is defined as a component that is configured to conduct wired or wireless communications with one or more other components. An “application” is defined as a program or programs that provide(s) an interface to enable a user to operate a computing device in accordance with one or more particular tasks. The term “operating environment” is defined as a particular setting that is associated with a device and is used to control multiple operations and configurations of the device.

An “interface” is defined as a component or group of components that at least receive(s) signals from a first device and transfers those signals to a second device in a form that is compatible with the second device. A “processor” is defined as one or more components that execute(s) sets of instructions. A “transceiver” is defined as a component or a group of components that transmit and receive radio or electronic signals. The term “enterprise” is defined as a group, organization, company or firm that is formed for one or more purposes and is not limited to those of a commercial nature. A “storage unit” is defined as a component or a group of components that are configured to store data in a machine-readable form. The term “directory service” is defined as a system that stores, organize and provides access to information. A “bundle” is defined as content that is intended for a particular communication device or a group of communication devices or one or more directives for directing the communication device or group of devices to one or more sources to obtain content. The term “managed device” is defined as a communication device that is configured to receive messages and take instructions from a centralized platform such that remote actions may be performed on the device under the direction of the platform.

As noted earlier, there is a trend towards enabling enterprises to manage mobile devices carried by persons associated with these organizations. The number of devices that must be authenticated and provisioned, however, is quite significant. There is a definite need for a quick and efficient process to ensure that authorized devices are authenticated and registered with a management service, with limited human interaction.

To do so, a method and system for automatic provisioning of communication devices is described herein. In particular, a management service can receive a pre-authorization request from a communication device, and the management service can redirect the communication device to a provisioning facilitator. The provisioning facilitator may then receive an authorization request from the communication device, which can be based on the pre-authorization request. This authorization request may be in a first form that is recognizable by the management service. The provisioning facilitator may convert the authorization request into a second form that is recognizable by a directory service. The provisioning facilitator may then obtain an authorization approval from the directory service, and the authorization approval may include a functional indicator that can correspond to a function associated with the operation of the communication device. Based on the authorization approval, the managing service may establish the communication device as a managed communication device and deliver a bundle to the managed communication device based on the functional indicator.

As such, numerous communication devices may be automatically authenticated and provisioned with little human interaction. Moreover, in view of the exchanges that occur here, the management service is not obligated to store or update significant pieces or amounts of information associated with users of the communication devices until such devices are authenticated and provisioned. Additionally, this provisioning process takes care to not jeopardize any security protocols or arrangements of the enterprise with which the user of the communication device may be associated.

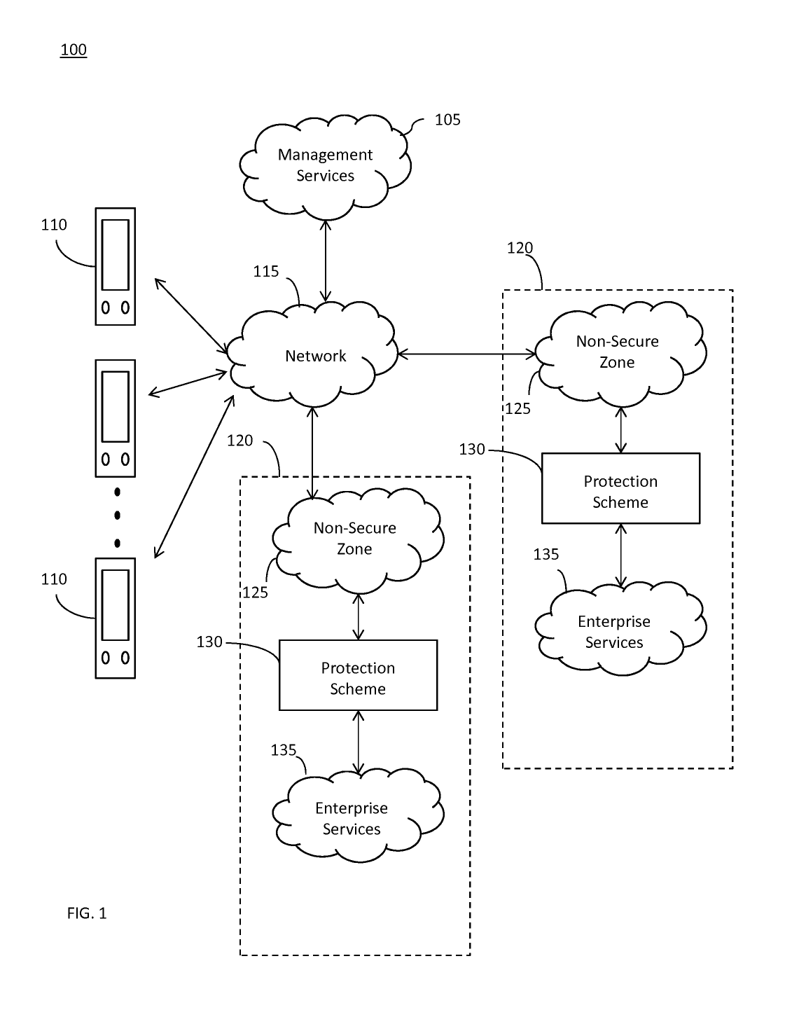

Referring to FIG. 1, an example of a system 100 for automatic provisioning of communication devices is shown. In one arrangement, the system 100 can include a management service 105, a plurality of communication devices 110, a network 115 and one or more enterprise networks 120. Once the communication devices 110 are authenticated, the management service 105 may enable the management of the communication devices 110, examples of which are provided in U.S. Patent Application Nos. 2012/0036442; 2012/0032945; 2012/0036440; 2012/0036552; 2012/0036245; and 2012/0036220, each of which is incorporated by reference herein. The communication devices 110 may be capable of wired or wireless communications (or both), and the network 115 can be any suitable combination of components and connections to facilitate communications between the devices 110 and the management service 105 or between other components/networks. For example, the network 115 may be capable of conducting both cellular and Wi-Fi communications.

The enterprise networks 120 may be associated with different enterprises. For example, these networks 120 may represent networks that enterprises have set up to conduct their operations. An enterprise may wish to manage or have managed the communication devices 110. As an example, an enterprise may provide communication devices 110 to its employees, which need to be authenticated prior to being granted access to sensitive enterprise data. Alternatively, some of the employees may own their own communication devices 110, and the enterprise may want to authenticate these devices 110 prior to these devices 110 being provided with such data. To assist these processes, the network 115 may facilitate communications between the communication devices 110 and the enterprise networks 120. If necessary, the network 115 may also enable communications between the enterprise networks 120 or between an enterprise network 120 and the management service 105.

In one arrangement, an enterprise network 120 may include a non-secure zone 125, a protections scheme 130 and enterprise services 135. For example, the non-secure zone 125 may be a subnetwork that is located external to the protection scheme 130 of the enterprise network 120 to facilitate communications between the enterprise network 120 and the network 115 or other unprotected or public networks. The protection scheme 130 can be any suitable bather for preventing unauthorized or unwanted communications between the network 115 and the enterprise services 135 or other sensitive platforms, an example of which is a firewall. The enterprise services 135 includes any service associated with the enterprise that may need to be protected from unauthorized access, examples of which will be provided below.

A brief, exemplary overview of the operation of the system 100 will now be presented. A user, who may be associated with an enterprise that maintains an enterprise network 120, may have a communication device 110 that requires authentication before the device 110 may access sensitive data related to the enterprise. To do so, the user of the device 110 may provide identification information to the device 110, which can generate a pre-authorization request for delivery to the management service 105. In turn, the management service 105 can redirect the device 110 to the appropriate enterprise network 120. The enterprise network 120, as will be outlined in detail below, may authenticate the device 110 and may provide a functional indicator to the device 110 that identifies a function of the user of the device 110. The device 110 may then forward the authentication and the functional indicator to the management service 105, which may then establish the device 110 as a managed device 110. The management service 105 may also deliver one or more bundles to the device 110, which may be based on the functional indicator.

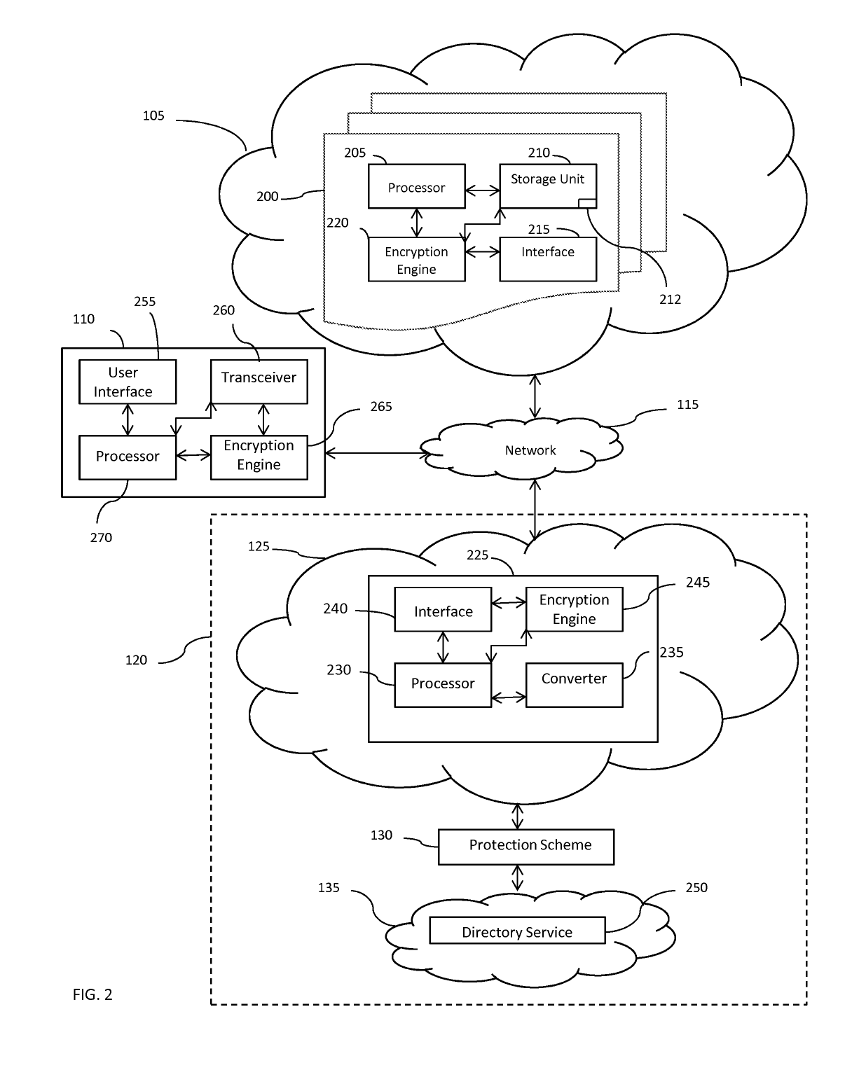

Referring to FIG. 2, several of the components of FIG. 1 are presented in more detail. For example, the management service 105 may include one or more management servers 200, each of which may contain a processor 205, a storage unit 210, an interface 215 and an encryption engine 220. Further, the non-secure zone 125 may include one or more provisional facilitators 225, each of which may contain a processor 230, a converter 235, an interface 240 and an encryption engine 245. A directory service 250 may be part of the enterprise services 135. In one embodiment, the storage unit 210 of the management server 105 may include a table 212, which can store identities of one or more provisioning facilitators 225.

Each communication device 110 may include a user interface element 255 that can be configured to receive input from and provide output to a user of the device 110. Suitable examples include touch-screen displays, keyboards, speakers, microphones, etc. The device 110 may also contain a transceiver 260 that is configured to receive signals from and transmit signals to any suitable network or component, such as the network 115. As mentioned earlier, this signal exchange includes both wired and wireless communications. An encryption engine 265 may also form part of the communication device 110 to encrypt outgoing transmissions and to decrypt incoming signals. The communication device 110 may also contain a processor 270, which can oversee the operation of the components described above.

Although many of the components described above are pictured as separate entities, it is understood that suitable combinations of these devices may be realized, where appropriate. For example, any of the encryption engine 220, the storage unit 210 or the interface 215 of the management server 105 may be integrated with or part of the processor 205. Similarly, any of the converter 235, the interface 240 or the encryption engine 245 of the provisioning facilitator 225 may be built into or be part of the processor 230. This same principle applies to the communication devices 110, the enterprise network 135 or any other component or system described herein.

The management server 200 may be responsible for overseeing the provisioning and the management of the communication devices 110, examples of which will be provided below. As such, the term “management server” is defined as a component or a group of components that establish one or more communication devices as managed devices and facilitate the management of such devices. To carry out these functions, the interface 215 may facilitate communications between the management server 200 and the network 115, while the encryption engine 220 can encrypt outgoing communications and decrypt incoming communications, if such security is warranted. The storage unit 210 may store any suitable type of data, such as bundles and other information related to the provisioning and management of the communication devices 110. The processor 205, which may be communicatively coupled to any of the other components of the management server 200, can execute instruction sets to ensure that the operations of the management server 200 are carried out, as will be described below.

Focusing on the non-secure zone 125, the provisioning facilitator 225 can communicate with portions of the enterprise services 135 to obtain data needed to provision the communication devices 110. That is, the provisioning facilitator 225 may establish communications with any number of components that are located in a protected environment of the enterprise, i.e., on the secure side of the protection scheme 130, to enable such a process. As an example, the provisioning facilitator 225 may also be referred to as a secure gateway. The term “provisioning facilitator” is defined as a component or a group of components that are external to a protected environment (or at least some of the components are external to the protected environment) and that communicate with one or more components that are internal to the protected environment in an effort to obtain data—including authenticating data—for purposes of provisioning communication devices.

To accommodate the operations of the provisioning facilitator 225, the interface 240 can facilitate communications between the facilitator 225 and the network 115. If necessary, another interface (not shown) may be implemented to accommodate communications between the facilitator 225 and the enterprise services 135. The encryption engine 245 can decrypt incoming communications from the network 115 and can encrypt outgoing communications to the network 115. In one arrangement, the converter 235 can receive requests from other components, like the communication devices 110, and translate them into a form that is recognizable by any number of components of the enterprise services 135. To assist in this process, the processor 230 can map data elements that are recognizable by the management service 105 to data elements that are recognizable by one or more parts of the enterprise services 135. The converter 235 can take advantage of this mapping during its translation operations. In addition, the processor 230 can be communicatively coupled to and control the operation of any of the components of the provisioning facilitator 225.

The enterprise services 135 can include any components or services that may be part of a network that is associated with a particular enterprise. For example, the network may be an intranet that is appropriately protected from the network 115 or any other network. As mentioned above, a directory service 250 may be part of the enterprise services 135. In one arrangement, the directory service 250 may store, organize and provide access to information of persons who are associated with the enterprise. For example, such persons may be employees, contractors, volunteers, partners, etc. of the enterprise who may be provided with or who may own one or more communication devices 110. Moreover, non-limiting examples of the information may include any of the following related to the associate of the enterprise: name, physical address, phone numbers, e-mail address, employee ID, business role or function, business unit, direct report(s), supervisor(s), passwords, etc. In fact, this information can be virtually any type of information related to the person associated with the enterprise, at least some of which the enterprise may deem as confidential or to be protected from unauthorized use. A suitable but non-limiting example of a directory service is the Lightweight Directory Access Protocol (LDAP).

In one arrangement, the information related to the associate of the enterprise that is part of the directory service 250 may not be shared with the management services 105, at least until the communication device 110 of this user has been authenticated. That is, prior to authenticating the user's communication device 110, information associated with this user may be restricted from storage at the management service 105. This information, however, may be stored at the directory service 250 both prior to and following the authentication of the device 110. In this embodiment, the management service 105 may conduct a “lazy discovery” process in that the service 105 is not required to store information about a specific user until the user's device 110 is authenticated. This scheme reduces the burden for the management service 105 to store and update such information, at least until the relevant communication device 110 is authenticated.

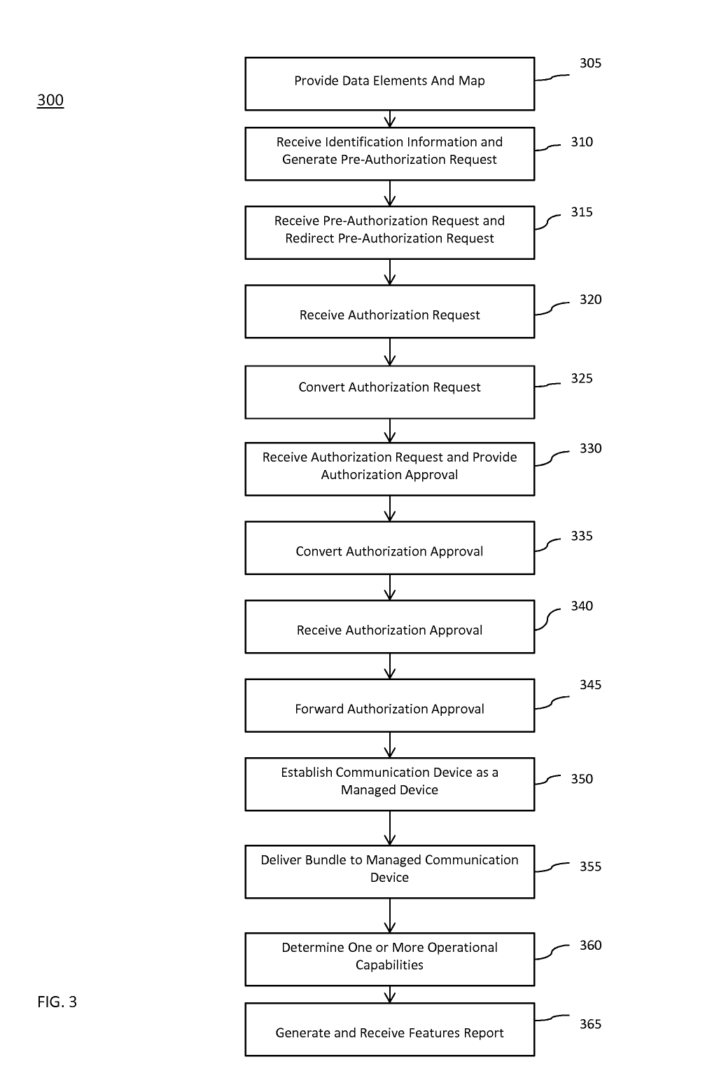

Non-limiting examples of the system 100 in action will now be presented. Referring to FIG. 3, a method 300 for automatically provisioning communication devices is shown. In describing this method 300, reference will be made to the components and descriptions related to FIGS. 1 and 2. It is understood, however, that the method 300 may be employed in other suitable systems and arrangements. Moreover, the method 300 is not intended to be limiting, as other related processes may include a greater or fewer number of steps in comparison to what is illustrated in FIG. 3.

At step 305, data elements can be provided to a provisioning facilitator, and these elements can be mapped to one another. For example, the provisioning facilitator 225 can be provided with data elements and an arranging of these elements from both the management service 105 and the directory service 250. These data elements and how they are arranged may demonstrate what type of information both the management service 105 and the directory service 250 store and how they organize it. In addition, the provisioning facilitator 225 can map the data elements of the management service 105 to those of the directory service 250. Thus, the provisioning facilitator 225 can create a correspondence between the data structures employed by the management service 105 and the directory service 250. In addition, this mapping process can be conducted for any directory service 250 and for multiple enterprises or for multiple branches of a single enterprise.

As part of this process, the enterprise can restrict the type of information that it shares with the management service 105. For example, the enterprise may not wish to provide to the management service 105 certain contact or personal information of its associates. To ensure such information is not breached, the directory service 250 may limit the type of data elements that are provided in this mapping process. As such, the enterprise may control the amount and type of information that may eventually be provided to the management service 105. This may remain true even if the management service 105 may accommodate such sensitive information.

At step 310, identification information may be received and a pre-authorization request may be generated at a communication device (or other authorized component). The pre-authorization request may be received at a management service, and the pre-authorization request may be redirected to the provisioning facilitator, as shown at step 315. For example, a user may wish to enable his/her communication device 110 to be provisioned and managed, such as by the management service 105. To start this process, the user may receive a message, such as an e-mail, or may visit an authorized Web site. In either arrangement, the user may download an initial application from the management service 105 or some other suitable service. When launched, the application may request information that is associated with the user, or identification information.

The user may provide such identification information through the user element 255 of the device 110 or though some other suitable component or service. As an example, the identification information may include certain credentials and an enterprise identifier. The term “identification information” is defined as information that helps to confirm or confirms the identity of the user and the enterprise with which the user is associated for purposes of establishing a managed communication device. Non-limiting examples of the credentials include a username and a password, and the enterprise identifier may be a domain name, such as a domain name of the enterprise.

Once the identification information is provided, the processor 270 of the communication device 110 may generate a pre-authorization request, which may contain all or at least a portion of the identification information, including the enterprise identifier. In addition, the encryption engine 265 may encrypt the pre-authorization request, and the transceiver 260 can forward the pre-authorization request to the management service 105. Once it receives the pre-authorization request from the communication device 110, the encryption engine 220 of the management server 105 can decrypt the request, and the processor 205 can determine the enterprise identifier. The processor 205 may then search the table 212 for a provisioning facilitator 225 that corresponds to the enterprise identifier to determine to which facilitator 225 the communication device 110 is to be directed. At this point, the management service 105 can redirect the communication device 110 to the appropriate provisioning facilitator 225. That is, the provisioning facilitator 225 to which the communication device 110 is directed can be assigned to an enterprise that is assigned the enterprise identifier that is part of the pre-authorization request.

Referring once again to FIG. 3, at steps 320 and 325, the authorization request can be received and appropriately converted at the provisioning facilitator. At step 330, the authorization request can be received at the directory service, and an authorization approval can be provided by the directory service. The authorization approval can also be appropriately converted by the provisioning facilitator, as shown at step 335, and at step 340, the authorization approval can be received by the communication device.

For example, once the communication device 110 has been redirected, the device 110—based on this feedback from the management service 105—can send an authorization request to the relevant provisioning facilitator 225. This authorization request may also be encrypted. In view of the interaction between the communication device 110 and the management service 105 described thus far, the identification information—and, hence, the pre-authorization request and the authorization request—may be in a first form that is recognizable by the management service 105. That is, in view of the initial download from the management service 105, the requested identification information may be arranged in accordance with the data structures and systems employed by the management service. The directory service 250, however, may not employ a similar arrangement. Thus, to access information from the directory service 250, any type of request should be in a form that is compatible with the directory service 250.

In view of this principle, once the relevant provisioning facilitator 225 receives and decrypts the authorization request from the communication device 110, the converter 235 of the facilitator 225 may convert the authorization request into a second form that is recognizable by the directory service 250. The term “convert” is defined as a process in which a request or communication in one form is made compatible for a particular service or device and includes significant changes to the request or communication or little or no changes to the request or communication. That is, the provisioning facilitator 225 may perform significant changes to the authorization request or may make little or no changes to the request, depending on the requirements of the directory service 250.

As part of this conversion, the provisioning facilitator 225 may rely on the schema mapping discussed earlier. That is, the facilitator 225 can convert the fields of the authorization request to a structure that is recognizable by the directory service 250. Schema mapping can provide the benefit of abstract data representation between the directory service 250 and both the communication devices 110 and the management server 200. Once in an acceptable form, the facilitator 225 can send the authorization request (via the protection scheme 130) to the directory service 250.

As noted earlier, the directory service 250 may contain information related to one or more associate of the enterprise. As such, when the directory service 250 receives the authorization request (in a form that it recognizes), the service 250 may authenticate the request. As part of this authentication, the service 250 may provide an authorization approval to the provisioning facilitator 225, which is in a form that is recognizable by the directory service 250. The authorization approval may include the identification information in the second form that is recognizable by the directory service 250. In addition, the service 250 may add additional fields to the original identification information. For example, the service 250 may add an approval field, a functional indicator field and one or more action fields.

The approval field may be an indication that the authorization request has been approved, while the functional indicator field may provide an indication as to the function or role of the associate of the enterprise who is attempting to provision the communication device 110. This field, as will be explained later, can be useful in ensuring the proper packages are downloaded to the device 110 for provisioning. The action fields may, when processed by the communication device 110, cause the device 110 to request the user to perform some action or the device 110 may take certain action in its own accord. For example, an action field may cause the communication device 110 to force the user to change his/her password before the provisioning of the device 110 can be finalized. Of course, the authorization approval can be amended with other suitable types of indicators or fields, as it is not limited to the examples recited here.

Once the provisioning facilitator 225 receives the authorization approval from the directory service 250, the converter 235 of the facilitator 225 may convert the approval into a form that is recognizable by the management service 105 and the communication device 110. That is, if necessary, the facilitator 225 can apply the schema mapping described earlier to place the authorization approval in the appropriate form for the device 110 and the management service 105. Once converted, the encryption engine 245 of the facilitator 225 can encrypt the authorization approval and forward it to the communication device 110, which can receive the approval through the network 115.

The above description assumes that the user can be authenticated. In some cases, however, the user may not be authenticated. For example, the user may have provided inaccurate information or the enterprise may determine that the user should not be provided with a managed communication device 110. If so, the authorization approval may be tagged with an indicator that indicates that authorization request has not been authenticated. Once it receives this message, the communication device 110 may inform the user that the device 110 cannot be provisioned.

Referring once again to FIG. 3, the authorization approval can be forwarded to the management service, and the communication device can be established as a managed device, as shown at steps 345 and 350. Additionally, a bundle may be delivered to the managed communication device, as illustrated in step 355.

For example, the communication device 110 may receive and decrypt the authorization approval, which can be in a form that is recognizable by the management service 105. If there are any action fields in the approval, the communication device 110 may undertake the appropriate action (e.g., asking the user to change the initial password). The communication device 110 may then encrypt the authorization approval and can forward it to the management service 105. The management service 105 may decrypt the approval and can use the information contained therein to establish the device 110 as a managed communication device 110. For example, the management server 200 can process the identification information plus any additional data provided by the directory service 250 to incorporate the device 110 into the management systems and processes of the management service 105 to enable the management of the device 110.

As part of this process, the processor 205 of the management server 200 can determine the functional indicator, which, as previously explained, may be related to a function of the user of the communication device 110. As an example, the function may be a role of the user in relation to the enterprise, such as a job title, description or status. As a particular example, a user may be a member of a sales team for an enterprise, and this status can be reflected in the functional indicator. In response to the determination of the functional indicator, the processor 205 may obtain content from the storage unit 210 and generate a bundle that is based on the functional indicator. The encryption engine 220 can encrypt the bundle, and the management server 200 can forward the bundle to the authenticated communication device 110.

In one arrangement, the communication device 110 may provide information that establishes the identity of the device 110 itself, and this information may be delivered to the management service 105, along with the authorization approval. For example, the device 110 may provide its International Mobile Equipment Identity (IMEI) or its Media Access Control (MAC) address. This information can enable the management service 110 to determine which content may be appropriate for the bundle to be delivered to the device 110. This information about the device 110 can supplement the information described above or may be in lieu of at least part of that information. For example, a bundle may be generated simply based on the identity information of the communication device 110.

Once the device 110 receives the bundle, the encryption engine 265 can decrypt the bundle, and the processor 270 can take the steps necessary to implement the bundle. For example, certain applications related to the user's function or role with the enterprise may be installed, and one or more policies may be applied. An example of a policy is the requirement that all communications involving enterprise data or applications is to be conducted over a secure connection. Other examples of how the incorporation of a bundle into a device may alter the operation and control of that device are presented in the applications mentioned earlier and incorporated by reference herein.

As part of this provisioning process, the communication device 110 may also be configured to support secure profiles or workspaces or at least support secure applications. For example, a personal profile that includes personal content and settings and a secure profile that supports secure content and settings may be established on the device 110. As a more specific example, the personal profile may include applications that are unsecured and operate in a conventional manner, while the secure profile may support applications that have been secured to restrict interaction with other applications and may require credentials to be accessed. In this arrangement, the user may be able to move between the personal and secure profiles, with the secure profile being used for operations associated with the enterprise. In another arrangement, a single profile may remain on the device 110, but applications that have been secured may be installed as part of the bundle. Again, these secure applications may be configured to limit their interactions only through appropriate channels and by entry of proper credentials.

Referring once again to FIG. 3, additional steps that may be part of the provisioning process will now be presented. At step 360, one or more operational capabilities of the communication device may be determined, and a features report can be generated by the communication device and received by the management service, as shown at step 365.

For example, when the communication device 110 is authenticated by the directory service 250, the device 110 may determine its operational capabilities and generate a features report that includes these capabilities. As a particular example, the device 110 may be equipped with a camera with a high resolution and may be capable of performing video calls. As another non-limiting example, the communication device 110 may be able to receive and process high-bandwidth signals. These features may be useful in the step of provisioning the communication device 110 with certain software packages. As such, the features report can be part of the authorization approval that is sent from the communication device 110 to the management service 105, or the features report can be sent separately.

Once the management service 105 receives the features report, the service 105 can use this information to tailor the bundle to the capabilities of the communication device 110. For example, if the device 110 supports video conferencing, the bundle may be constructed to include an application that facilitates such a feature and policies that manage its use.

Once the bundle is delivered, the communication device 110 may be considered to be provisioned. At this point, the device 110 may be managed and certain settings may be affected on the device 110. Thus, the user of the device 110, who is typically associated with the enterprise, may be able to access sensitive data that is related to the enterprise, with appropriate security procedures and policies in place. This provisioning process can be conducted for multiple communication devices 110 and for numerous enterprises and users of those devices 110. The term “provisioned communication device” is defined as a communication device in a state in which the device has been authenticated, is capable of being managed and has been equipped with material to enable a user to operate the device at a level of control in compliance with guidelines established by a party.

While various embodiments have been described above, it should be understood that they have been presented by way of example only, and not limitation. It will be understood by those skilled in the relevant art(s) that various changes in form and details may be made therein without departing from the spirit and scope of the invention as defined in the appended claims. Accordingly, the breadth and scope of the present invention should not be limited by any of the above-described exemplary embodiments, but should be defined only in accordance with the following claims and their equivalents.

What is claimed is:

1. A method for automatic provisioning of communication devices, comprising:
receiving a pre-authorization request from a communication device;
receiving an authorization request based on the pre-authorization request, wherein the authorization request is in a first form;
converting the authorization request into a second form that is recognizable by a directory service;
obtaining an authorization approval from the directory service, wherein the authorization approval includes a functional indicator that corresponds to a function associated with the operation of the communication device;
based on the authorization approval, establishing the communication device as a managed communication device; and
delivering a bundle to the managed communication device based on the functional indicator.

2. The method according to claim 1, wherein the pre-authorization request includes an enterprise identifier.

3. The method according to claim 2, further comprising redirecting the pre-authorization request to a provisioning facilitator based on the enterprise identifier, wherein the provisioning facilitator is assigned to an enterprise that is assigned the enterprise identifier.

4. The method according to claim 1, further comprising mapping data elements associated with a management service with data elements of the directory service to enable the converting of the authorization request from the first form to the second form that is recognizable by the directory service.

5. The method according to claim 1, further comprising:
converting the authorization approval into the first form; and
transmitting the authorization approval to the communication device.

6. The method according to claim 1, further comprising:
decrypting the pre-authorization request when the pre-authorization request is received from the communication device;
decrypting the authorization request when the authorization request is received; and
encrypting the authorization approval when the authorization approval is obtained from the directory service.

7. The method according to claim 1, wherein the directory service is part of a protected environment of an enterprise and the method further comprises receiving the functional indicator from the directory service.

8. The method according to claim 1, further comprising receiving a features report from the communication device, wherein the features report includes operational capabilities of the communication device.

9. A method for automatically provisioning a communication device, comprising:
receiving identification information that is used to form a pre-authorization request;
sending the pre-authorization request to a management service;
based on feedback from the management service, sending an authorization request to a provisioning facilitator, wherein the authorization request is in a form that is recognizable by the management service;
receiving the authorization request in a form that is recognizable by a directory service;
in response to the authorization request, selectively providing an authorization approval in the form that is recognizable by the directory service;
receiving the authorization approval in a form that is recognizable by the management service; and
based on the authorization approval, receiving at the communication device a bundle that is selected in view of a function of a user who is associated with the directory service.

10. The method according to claim 9, wherein the identification information includes an enterprise identifier and the enterprise identifier is associated with the provisioning facilitator that receives the authorization request.

11. The method according to claim 9, further comprising:
encrypting the pre-authorization request for transmission to the management service; and
decrypting the authorization approval when the authorization approval is received.

12. The method according to claim 9, wherein the authorization approval includes a functional indicator and the functional indicator determines the bundle that the communication device receives.

13. The method according to claim 9, further comprising:
prior to authenticating the communication device, restricting user information from storage at the management service; and
storing the user information at the directory service prior to and following the authentication of the communication device.

14. The method according to claim 9, further comprising selectively providing data elements of the directory service to enable the provisioning facilitator to map the data elements of the directory service to data elements of the management service.

15. The method according to claim 9, further comprising:
determining one or more operational capabilities of the communication device; and
sending the operational capabilities to the management service as part of a features report, wherein the features report affects the provisioning of the communication device.

16. A method of automatically provisioning a communication device, comprising:
receiving identification information;
generating a pre-authorization request based on the identification information;
sending the pre-authorization request to a management service;
based on feedback from the management service, sending an authorization request to a provisioning facilitator that is communicatively coupled to a directory service in a protected environment of an enterprise;
receiving from the provisioning facilitator an authorization approval;
sending the authorization approval to the management service; and
receiving a bundle from the management service, wherein the bundle is based on a function of a user who is associated with the enterprise.

17. A system for automatic provisioning of communication devices, comprising:
a management server, wherein the management server is configured to receive a pre-authorization request from a communication device; and
a provisioning facilitator, wherein the provisioning facilitator is configured to communicate with a directory service of an enterprise;
wherein the management server is further configured to redirect the communication device to the provisioning facilitator based on the pre-authorization request;
wherein the provisioning facilitator is further configured to receive an authorization request from the communication device in a form that is recognizable by the management server and to convert the authorization request into a form that is recognizable by the directory service;
wherein the provisioning facilitator is further configured to receive an authorization approval from the directory service and based on this authorization approval, the management server is further configured to deliver a bundle to the communication device to convert the communication device to a managed communication device.

18. The system according to claim 17, wherein the management server is further configured to deliver the bundle to the communication device based on a function of a user of the communication device.

19. The system according to claim 17, wherein the management server includes a table that stores identities of one or more provisioning facilitators.

20. The system according to claim 19, wherein the pre-authorization request contains an enterprise identifier and the management server further includes a processor, wherein the processor searches the table for a provisioning facilitator that corresponds to the enterprise identifier to determine which provisioning facilitator is to receive the authorization request from the communication device.

21. The system according to claim 17, wherein the management server includes an encryption engine that is configured to decrypt the pre-authorization request from the communication device and to encrypt the bundle that is delivered to the communication device.

22. The system according to claim 17, wherein the management server includes one or more storage units that are configured to store bundles that are to be delivered to the communication devices.

23. The system according to claim 17, wherein the provisioning facilitator is further configured to map data elements that are associated with the management server to data elements that are associated with the directory service.

24. The system according to claim 17, wherein the directory service is within a protected environment of the enterprise and the provisioning facilitator is outside the protected environment of the enterprise.

25. The system according to claim 17, wherein the management server is further configured to receive and process a features report from the communication device, wherein the features report includes operational capabilities of the communication device.

26. A communication device, comprising:
a user interface element, wherein the user interface element is configured to receive identification information that is associated with a user who is assigned to an enterprise;
a transceiver that is configured to receive and transmit communication signals;
a processor that is communicatively coupled to the user interface element and the transceiver, wherein the processor is configured to:
generate a pre-authorization request based on the identification information;
cause the transceiver to send the pre-authorization request to a management service;
based on feedback from the management service, cause the transceiver to send an authorization request to a provisioning facilitator that is communicatively coupled to a directory service of the enterprise;
receive an authorization approval from the provisioning facilitator;
cause the transceiver to send the authorization approval to the management service; and
receive and process a bundle from the management service, wherein the bundle is based on a function of the user who is assigned to the enterprise.

27. The communication device according to claim 26, wherein the identification information includes an identifier for the enterprise.

28. The communication device according to claim 27, wherein the identifier for the enterprise is a domain name.

29. The communication device according to claim 26, further comprising an encryption engine, wherein the encryption engine is configured to encrypt the pre-authorization request and the authorization approval prior to transmission to the management service and to decrypt the authorization approval from the provisioning facilitator.

30. The communication device according to claim 26, wherein the processor is further configured to generate a features report for transmission to the management service, wherein the features report includes operational capabilities of the communication device.
